(19) United States
(12) Patent Application Publication
(10) Pub. No.: US 2008/0126599 A1
(43) Pub. Date: May 29, 2008

(54) ISCSI TARGET APPARATUS THAT DOES NOT REQUIRE CREATING A BUFFER IN THE USER SPACE AND RELATED METHOD THEREOF

(76) Inventors: Chung-Yu Wei, Kao-Hsiung City (TW); Kuang-Chih Liu, Hsin-Chu City (TW); Chih-Feng Chien, Hsin-Chu City (TW); Luen-Ming Shen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/467,906

(22) Filed: Aug. 28, 2006

(51) Int. Cl. G06F 13/14; G06F 13/28

(52) U.S. Cl. 710/22; 710/52

(57) ABSTRACT

An iSCSI target apparatus is disclosed. The iSCSI target apparatus includes a buffer device, a network interface, and a host storage hardware. The buffer device is for buffering at least a packet. The network interface is coupled to the buffer device for accessing the buffer device to transfer the packet between the network interface and the buffer device. The host storage hardware is coupled to the buffer device for accessing the buffer device to transfer the packet between the host storage hardware and the buffer device. Movement of the packet in the iSCSI target apparatus only occurs between the network interface and the buffer device and between the host storage hardware and the buffer device.

### BACKGROUND OF THE INVENTION

1. Field of the Invention

The invention relates to an iSCSI target apparatus, and more particularly, to an iSCSI apparatus that does not require creating a buffer in the user space.

2. Description of the Prior Art

iSCSI is an Internet Protocol (IP) based storage networking standard that enables Small Computer System Interface (SCSI) data to be transported in blocks over the Internet. The SCSI commands and data are encapsulated in TCP/IP packets, for linking storage devices with servers. iSCSI transports SCSI commands over IP networks, thereby enabling data transfer and managing storage over long distances. It also enables location-independent storage and retrieval.

SCSI commands are typically sent from a server/initiator device to a client/target device over an Ethernet connection. The initiator is a driver that handles the SCSI traffic over iSCSI, and initiates all SCSI operations, e.g. read and write. It can be implemented as either a software or a hardware device. The iSCSI target performs the SCSI commands, or bridges the commands to an attached storage device.

Please refer to FIG. 1. FIG. 1 is a diagram of an iSCSI system 100 according to the prior art. As can be seen, the system 100 comprises an iSCSI initiator 200, and an iSCSI target 300, where the iSCSI initiator 200 communicates with the iSCSI target 300 via an Ethernet connection 110. A command is created in the iSCSI initiator 200 from the Mass Storage Application 210 in the user space, and the File System 220 in the kernel space is accessed to determine whether the command already exists in the cache. If not, then the command is passed to the Block I/O layer 230, for merging the data request into a single request command, as the command may involve accessing several areas of a storage device such as a hard disk. The command is then passed to a SCSI service 232. In addition to controlling data access of the host storage hardware 290, the host storage hardware having a host adapter 292 and a storage device 294, the SCSI service 232 is capable of transforming the received command into packets complying with an iSCSI protocol. The TCP driver 234 converts iSCSI packets into TCP packets, and then the IP driver 236 converts the TCP packets into IP packets. The packet generation is well known to those skilled in this art, and further description is omitted here for brevity. The MAC Driver 240 then transports the data to the iSCSI target, using the Network Interface 250.

The iSCSI target 300 receives the data over the Network Interface 310, and the received data are transmitted to the iSCSI Target API 330 via the MAC driver 312, the IP driver 314 and the TCP driver 316. As shown in FIG. 1, the iSCSI target 300 copies the data to a first buffer 320 in the kernel space, and then parses the data. This is performed by the iSCSI Target API 330, and involves copying the data from the first buffer 320 to a second buffer 340 in the user space. The File System 350 is accessed for determining whether the command already exists in the cache, and, if storage access (i.e. hard disk access) is required, the command is passed to the Block I/O layer 360 for merging into a single request command. These two steps require further copying of the data from the second buffer 340 to a third buffer 370 in the kernel space. Finally, the bus driver 380 is utilized to drive access to the host storage hardware 390 for performing the command. As shown in FIG. 1, the host storage hardware 390 comprises a host adapter 392 and a storage device 394. For example, the bus driver 380 is an IDE or SATA driver, the host adapter 392 is an IDE bus adapter, and the storage device 394 is a hard-disk drive.

The copying of data from kernel space to user space and then back to kernel space creates heavy CPU overhead, and degrades the overall performance of the system. Furthermore, the utilization of the File System 350 and Block I/O layer 360 adds extra steps to the operation.

### SUMMARY OF THE INVENTION

It is therefore an objective of the present invention to provide a system for carrying out iSCSI commands that does not require copying data from the kernel space to the user space. It is a further objective to provide a system that does not include a Block I/O layer and a File System on the target side.

Briefly described, an embodiment of an iSCSI target apparatus according to the present invention comprises a buffer device, a network interface, and a host storage hardware. The buffer device is for buffering at least a packet. The network interface is coupled to the buffer device for accessing the buffer device to transfer the packet between the network interface and the buffer device. The host storage hardware is coupled to the buffer device for accessing the buffer device to transfer the packet between the host storage hardware and the buffer device. Movement of the packet in the iSCSI target apparatus only occurs between the network interface and the buffer device and between the host storage hardware and the buffer device.

A method of transmitting a packet in an iSCSI apparatus is also disclosed. The method comprises: providing a buffer device, a network interface, and a host storage hardware; accessing the buffer device to transfer the packet between the network interface and the buffer device; and accessing the buffer device to transfer the packet between the host storage hardware and the buffer device. Movement of the packet only occurs between the network interface and the buffer device and between the host storage hardware and the buffer device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an iSCSI system according to the prior art.

FIG. 2 is a diagram of an iSCSI target apparatus according to an embodiment of the present invention.

FIG. 3 is a detailed diagram of a buffer shown in FIG. 2.

### DETAILED DESCRIPTION

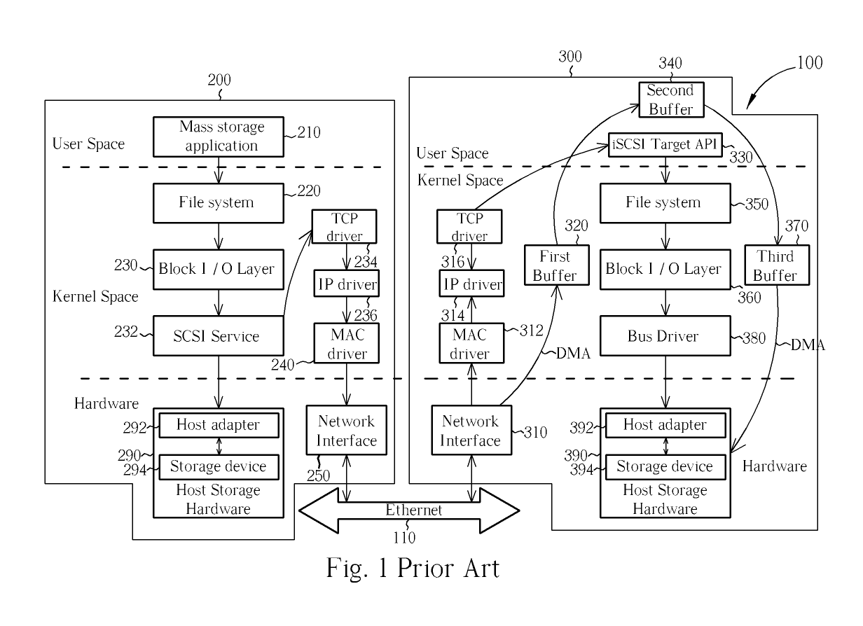

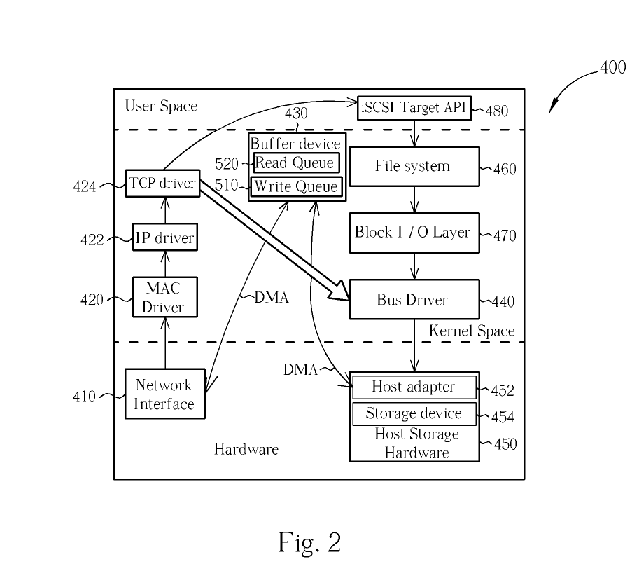

Please refer to FIG. 2. FIG. 2 is a diagram of an iSCSI target apparatus 400 according to an embodiment of the present invention. The iSCSI target apparatus 400 comprises: a network interface 410; a MAC driver 420; an IP driver 422; a TCP driver 424, a buffer device 430; a bus driver 440; a host storage hardware 450 consisting of a host adapter 452 and a storage device 454; a file system 460; and a block I/O layer 470. The buffer device 430 further comprises a read queue 520 and a write queue 510, each queue containing a look-up table. In this embodiment, the bus driver 440 is an IDE or SATA driver, the host adapter 452 is an IDE or SATA bus adapter, and the storage device 454 is a hard-disk drive. This is not meant to be taken as a limitation of the present invention, however. In addition, the components of the same name in FIG. 1 and FIG. 2 have the same operation and functionality. Further description is therefore omitted for brevity.

The storage access packets (i.e. SCSI data packets) consist of command packet data units (PDUs), being Write Cmd PDUs and Read Cmd PDUs, and data packet data units, being Data Out PDUs, and Data In PDUs. Please note that Data In PDUs are created in the iSCSI target apparatus 400. Initially, the above data PDUs and command PDUs are received by the network interface 410, and copied to the buffer 430 in the kernel space utilizing Direct Memory Access (DMA). In other words, no buffer exists in the user space in this embodiment. The iSCSI Target API 480 is only utilized for parsing PDUs that are not related to disk access or disk access commands, e.g. Login and Logout PDUs. All data and command PDUs are kept in the kernel space buffer device 430 until a DMA movement by the host storage hardware 450 occurs, driving the data PDUs to access the storage device 454. In this way, movement of the data and command PDUs only occurs according to DMA movement rather than by a CPU, thereby greatly reducing the CPU overhead. Read PDUs are created in the kernel space buffer device 430, for receiving data read from the storage device 454. Advantageously, only one buffer is required to be implemented in the kernel space of the iSCSI target apparatus 400.

It should be noted that the MAC driver 420 is responsible for enabling DMA movement of packets between the network interface 410 and the buffer device 430; and the bus driver 440 is responsible for enabling DMA movement of packets between the host storage hardware 450 and the buffer device 430.

When data PDUs and command PDUs are received by the iSCSI target apparatus 400, a read queue 520 and a write queue 510 are created in the buffer device 430. The read and write queues 510, 520 contain a look-up table respectively, detailing the status of each PDU, i.e. whether the PDU has been received by the buffer device 430 as indicated by a ‘received’ descriptor, and whether the PDU has been released from the buffer device 430 as indicated by a ‘transmitted’ descriptor. The read queue 520 creates a read PDU for containing data to be read from the storage device 454, and assigns a space in the buffer device 430. The write queue look-up table further contains the address (i.e. a DMA descriptor) in the buffer device 430 that contains a write PDU to be written to the storage device 454, and the read queue look-up table further contains the address (i.e. a DMA descriptor) in the buffer device 430 that contains the created read PDU.

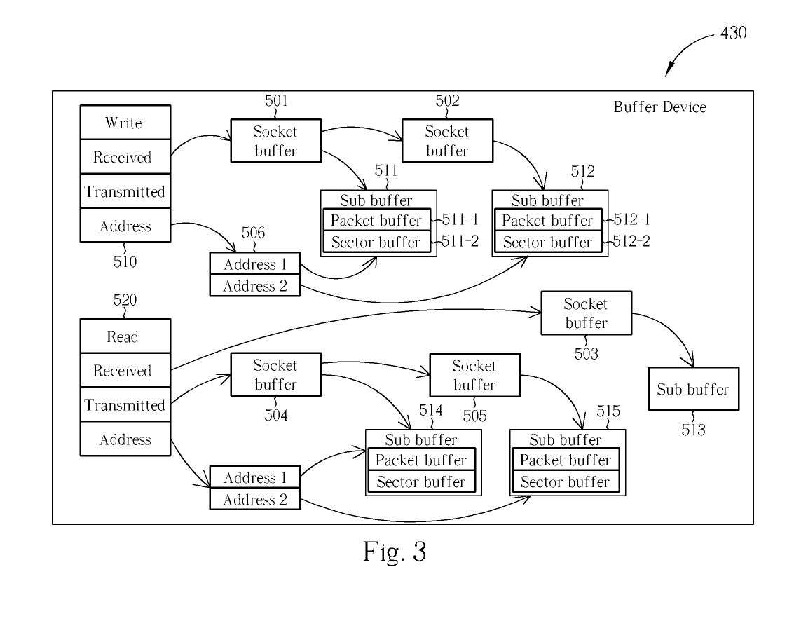

Please refer to FIG. 3. FIG. 3 is a detailed diagram of the buffer device 430 shown in FIG. 2. The buffer device 430 includes a plurality of buffer units. As shown in FIG. 3, the buffer device 430 contains a plurality of socket buffers 501, 502, 503, 504, 505, and a plurality of sub buffers 511, 512, 513, 514, 515. In FIG. 3 only five socket buffers and five sub buffers are shown, however, this is not meant to be a limitation of the buffer device 430 and more socket and sub buffers can be utilized according to design considerations. For simplicity, the read and write operations will herein be described separately. The socket buffers 501, 502 receive the Write Cmd PDUs/Data Out PDUs, and then store the Write Cmd PDUs/Data Out PDUs to the sub buffers 511, 512, respectively. The sub buffers 511, 512 are further viewed as packet buffers 511-1, 512-1, for containing the write data, or as sector buffers 511-2, 512-2, for containing a scatter and gather descriptor 506 of each Data Out PDU. The scatter and gather descriptor 506 and sector buffer 511-2 or 512-2 enables the write queue 510 to locate a specific Data Out PDU to be written to the host storage hardware 450. The write queue 510 shows that a specific Data Out PDU has been written to the buffer device 430. When a DMA movement is performed by the host storage hardware 450, the Data Out PDU will be moved from the buffer device 430 to the host storage hardware 450, and the look-up table in the write queue 510 will be updated accordingly.

The read operation will be described herein. The read queue 520 only contains Read Cmd PDUs, and sends them to the socket buffer 503, and has the corresponding sub buffer 513. Data packets (i.e. Data In PDUs) for containing data read from the host storage hardware 450 are created, and stored in socket buffers 504 and 505, and their corresponding sub buffers 514 and 515 respectively are also created. When a DMA movement is performed by the host storage hardware 450, data will be moved from the host storage hardware 450 and written to the Data In PDU created in the sector buffer 514 or 515. The read queue 520 contains the address of the specific buffer to be written to, and updates the look-up table accordingly.

The utilization of the write queue 510 and read queue 520 enables the read and write PDUs to be implemented in the kernel space rather than the user space. No CPU overhead is required when performing read and write commands, as all commands are performed by DMA, and no data copying is required. Furthermore, the File System and Block I/O layers modules are not utilized when carrying out read and write commands, and therefore the speed of read and write operations is greatly increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An iSCSI target apparatus, comprising:
a buffer device, for buffering at least a packet;
a network interface, coupled to the buffer device, for accessing the buffer device to transfer the packet between the network interface and the buffer device; and
a host storage hardware, coupled to the buffer device, for accessing the buffer device to transfer the packet between the host storage hardware and the buffer device;
wherein movement of the packet in the iSCSI target apparatus occurs between the network interface and the buffer device and between the host storage hardware and the buffer device.

2. The apparatus of claim 1, wherein the packet is a storage access packet.

3. The apparatus of claim 2, wherein the packet is a Read Cmd PDU, a Write Cmd PDU, a Data Out PDU or Data In PDU.

4. The apparatus of claim 1, wherein the network interface and the host storage hardware have Direct Memory Access (DMA) functionality, and movement of the packet is DMA movement.

5. The apparatus of claim 4, further comprising:
a MAC driver, for enabling DMA movement of the packet between the network interface and the buffer device; and
a bus driver, for enabling DMA movement of the packet between the host storage hardware and the buffer device.

6. The apparatus of claim 1, wherein the buffer device comprises:
a plurality of buffer units each for buffering a packet; and
a queue, comprising at least the packet for accessing a specific buffer unit of the buffer units and a look-up table containing status information of at least the packet.

7. The apparatus of claim 6, wherein the status information in the look-up table comprises a DMA descriptor relating to an address of the specific buffer unit and a transmission state of the packet.

8. The apparatus of claim 1, wherein the host storage hardware comprises:
a host adapter; and
a storage device, coupled to the host adapter.

9. The apparatus of claim 8, wherein the host adapter is an IDE or SATA bus adapter.

10. The apparatus of claim 1, wherein the network interface is a MAC controller.

11. A method of transmitting a packet in an iSCSI target apparatus, comprising:
providing a buffer device, a network interface, and a host storage hardware;
accessing the buffer device to transfer the packet between the network interface and the buffer device; and
accessing the buffer device to transfer the packet between the host storage hardware and the buffer device;
wherein movement of the packet occurs between the network interface and the buffer device and between the host storage hardware and the buffer device.

12. The apparatus of claim 10, wherein the packet is a storage access packet.

13. The apparatus of claim 12, wherein the packet is a Read Cmd PDU, a Write Cmd PDU, a Data Out PDU or Data In PDU.

14. The method of claim 11, wherein the step of accessing the buffer device to move the packet between the network interface and the buffer device further comprises:
providing the network interface with Direct Memory Access (DMA) functionality; and
moving the packet utilizing DMA; and the step of accessing the buffer device to move the packet between the host storage hardware and the buffer device further comprises:
providing the host storage hardware with Direct Memory Access (DMA) functionality;
and moving the packet utilizing DMA.

15. The method of claim 11, wherein providing the buffer device comprises:
providing a plurality of buffer units each for buffering a packet; and
providing a queue, comprising at least the packet for accessing a specific buffer unit of the buffer units and a look-up table containing status information of at least the packet.

16. The method of claim 15, wherein the status information in the look-up table comprises a DMA descriptor relating to an address of the specific buffer unit and a transmission state of the packet.
